(19) United States
(12) Patent Application Publication
(10) Pub. No.: US 2020/0342497 A1
(43) Pub. Date: Oct. 29, 2020

(54) METHOD OF AND SERVER FOR TRANSMITTING TARGETED MESSAGE TO USER ELECTRONIC DEVICE

(71) Applicant: YANDEX EUROPE AG, Luzern (CH)

(72) Inventors: Vasily Vadimovich ASTAKHOV, Moscow (RU); Artem Viktorovich VOROZHTSOV, Kirovo-Chepetsk (RU); Maksim Ilich STEBELEV, Khimki (RU); Aleksey Vladimirovich STYSIN, Moscow (RU)

(21) Appl. No.: 16/659,064

(22) Filed: Oct. 21, 2019

(30) Foreign Application Priority Data
Apr. 25, 2019 (RU) 2019112781

(51) Int. Cl. G06Q 30/02; G06F 16/9535; H04W 4/12; H04L 12/58

(52) U.S. Cl. CPC G06Q 30/0261; G06Q 30/0269; G06Q 30/0255; H04L 51/04; G06F 16/9535; H04W 4/12; H04L 51/36; G06Q 30/0267

(57) ABSTRACT

A method for transmitting a targeted electronic message for a user of an electronic device. The method comprises: responsive to a request retrieving a plurality of candidates for the targeted electronic message; retrieving a plurality of stencils having a dedicated placement pattern for one or more targeted electronic messages; for each of the plurality of stencils, selecting by the server a respective set of targeted electronic messages, the selecting being executed such that a total value parameter of the respective set of targeted electronic messages out of possible combinations of the plurality of candidates for the targeted electronic message is maximized for each given one of the plurality of stencils; selecting a stencil to be transmitted to the electronic device of the plurality of stencils, the stencil to be transmitted having a highest value of the total value parameter.

### CROSS-REFERENCE

The present application claims priority to Russian Patent Application No. 2019112781, entitled “Method of and Server for Transmitting Targeted Message to User Electronic Device”, filed Apr. 25, 2019, the entirety of which is incorporated herein by reference.

### FIELD

The present technology relates to transmission of data in general, and to a method of and a system for transmitting a targeted message to a user electronic device.

### BACKGROUND

Various global or local communications networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

The user can access the information available on the Internet by several means. The given user can access a particular resource directly, either by typing an address of the resource (typically an URL or Universal Resource Locator) or by clicking a link in an e-mail or in another web resource. This is particularly useful when the user knows what the resource she or he is interested in.

Alternatively, the given user may conduct a search using a search engine to locate a resource of interest. The latter is particularly suitable in those circumstances, where the given user knows a topic of interest, but does not know the exact address of the resource she is interested in. There are numerous search engines available to the user. Some of them are considered to be general purpose search engines (such as Yandex™, Google™, Yahoo™ and the like). Others are considered to be vertical search engines—i.e. search engines dedicated to a particular topic of search—such as Momondo™ search engine dedicated to searching flights. Irrespective of which search engine is used, the search engine is generally configured to receive a search query from a user, to perform a search and to return a ranked search engine results page (SERP) to the user.

When accessing the particular web site or conducting the search, the user can be presented with generic content or personalized content. The generic content is the content that would be shown to any user accessing the particular resource without taking into account user-specific parameters, such as user interests, user interaction history and the like. Personalized content is a type of content that is specifically targeted for the given user, based on predicted or known user interest parameters. Thus, the personalized content can be thought of as “targeted content”.

For example, the search result ranking on any given SERP can be generic (using a generic search engine result ranking algorithm) or personalized for the given user (i.e. ranked at least in part based on the information known about the given user, such as past queries, past search result interactions and the like). By the same token, a given web resource can provide generic content and personalized content to the user. Personalized content can take many forms, such as a targeted message incorporated into the content of the web site, the targeted message having been selected for the given user as a relevant message based on certain information known about the given user. The targeted message can be provided by a provider of the generic content of the given web resource or, alternatively, it can come from a third-party source and inserted into the generic content otherwise available on the web resource.

Continuing with the example of the SERP, some search results can be generic and ranked using the generic search engine result ranking algorithm, while other results can be targeted electronic messages. These can take form of electronic ad banners or search results associated with “special placement” within the SERP. This special placement may or may not be aligned with the rank of these specially placed search results, if their rank was determined using the generic search engine result ranking algorithm.

Generally, such special placement is selected to drive user attention to the specially placed targeted electronic message and, therefore, to cause the user to execute a pre-determined desired action. The pre-determined desired action can be user interaction with the targeted electronic message, the user visiting a network resource associated with a source of the targeted electronic message, the user executing a pre-determined action associated with the network resource, and the like.

As such, the special placement for the targeted electronic message is typically associated with a special arrangement, such as a source of such specially-places targeted electronic message having to pay for such placement to either a provider of the search engine or a provider of an electronic ads platform.

With reference to FIG. 1, there is depicted a typical prior art system (not numbered) for delivering personalized content to a user 104 of an electronic device 102 over a communication network 106. To that end, coupled to the communication network 106 are a content provider server 108 and a personalized content provider server 110. Let it now be assumed that the user 104 is desirous of accessing a web resource 112 hosted by the content provider server 108. To that end, the electronic device 102 can execute a browser, such as a GOOGLE™ browser, a YANDEX™ browser, a SAFARI™ browser and the like. Let is also be assumed that the user 104 types in a URL address associated with the network resource 112.

In response to the user 104 attempt to access the network resource 112, the electronic device 102 generates a resource request 120 in accordance with a suitable communication protocol and transmits it, via the communication network 106, to the content provider server 108. The content provider server 108 receives the resource request 120 and determines that the network resource 112 is what the user 104 is looking for (based on the URL, for example, the process known as “address resolving”). The content provider server 108 determines that the network resource 112 contains a generic portion and a personalized portion. The content provider server 108 can further determine that the content of the generic portion is stored by the content provider server 108 and that the content for the personalized portion is stored by the personalized content provider server 110. To that end, the content provider server 108 sends a personalized content request 122 via the communication network 106 (or a separate network, as the case may be) to the personalized content provider server 110. The personalized content request 122 includes inter alia an indication of a user identifier and/or an indication of user interests associated with the user 104.

Based on the user identifier and/or the user interests, the personalized content provider server 110 selects content for the targeted content portion and transmits a targeted content portion data 124, via the communication network 106, to the content provider server 108. The targeted content portion data 124 can, for example, contain a script for embedding into the personalized portion of the network resource 112, the script, when executed on the electronic device 102, for downloading the personalized content from the personalized content provider server 110.

A system to that depicted in FIG. 1 is configured to place targeted electronic messages into SERPs destined to the user, whereby the content provider server 108 can be implemented as a search engine server. In these embodiments, the personalized content provider server 110 can be implemented as part of the search engine server.

### SUMMARY

It is an object of the present technology to ameliorate at least some of the inconveniences present in the prior art.

Non-limiting embodiments of the present technology are directed to method and systems for delivering targeted content (i.e. a targeted electronic message) to a user electronic device. In at least some non-limiting embodiments of the present technology, the system is configured to select the targeted electronic message based on an “auction” model where sources of the targeted electronic messages bid for inclusion of their targeted electronic messages for an impression to the user (as part of a Search Engine Results Page or SERP for short, as part of a network resource, or the like).

In some non-limiting embodiments of the present technology, method and systems described herein are implemented in a placement system for search and content ads (which are examples of targeted electronic messages). Originators of such targeted electronic messages pay for clicks on targeted electronic messages (such as banner ads or the like), which can be displayed in ad blocks on a SERP and/or through ad networks (an example of which is a Yandex Advertising Network and ad exchanges).

In at least some of the non-limiting embodiments of the present technology, a “click cost” (i.e. an amount charged to the source of the targeted electronic message for the user clicking on the targeted electronic message or the user executing another pre-determined desired action in association with the targeted electronic message) is not fixed. Rather, the click cost can be determined based on the results of an auction among advertisers (i.e. multiple sources of targeted electronic messages who “compete” for placement into a given SERP, as an example). In those embodiments, where the targeted electronic message is to be places into the SERP, the auction takes place in real time, while the user loads the search results page or a page containing ad blocks.

Broadly speaking, non-limiting embodiments of the present technology aim to generate a set of targeted electronic messages (for a given instance of an impression to a user) based on a bid auction. In a sense, the non-limiting embodiments of the present technology approach the bid auction as an optimization task. Broadly speaking, the goal of the optimization task is to select such a set of targeted electronic messages such that to maximize the value of the set of targeted electronic messages. The concept of “value” in accordance with the non-limiting embodiments of the present technology is multi-faceted.

Some examples of the components that contribute to the value are but are not limited to:

User-specific factors—relevance of the given targeted electronic message to the user;

Source-specific factors—these are factors associated with the source of the given targeted electronic message: click through rate (CTR) prediction, bid values having been pre-set by the source, etc.;

Combined factors—prediction of the conversion (i.e. likelihood of the user that is exposed to the given targeted electronic message to execute a desired action either with the given targeted electronic message or with a network resource associated with the source of the given targeted electronic message).

In accordance with a first broad aspect of the present technology, there is provided a method for transmitting a targeted electronic message for a user of an electronic device. The method is executable by a server coupled to the electronic device via a communication network. The method comprises: receiving, by the server, a request for the targeted electronic message to be transmitted to the electronic device; retrieving, from a database of electronic messages, a plurality of candidates for the targeted electronic message; retrieving a plurality of stencils, each of the plurality of stencils having a dedicated placement pattern for one or more targeted electronic messages; for each of the plurality of stencils, selecting by the server a respective set of targeted electronic messages, the respective set of targeted electronic messages having one or more targeted electronic messages, the selecting being executed such that a total value parameter of the respective set of targeted electronic messages out of possible combinations of the plurality of candidates for the targeted electronic message is maximized for each given one of the plurality of stencils; analyzing, by the server, the plurality of stencils each having been assigned with the respective set of targeted electronic messages to select a stencil to be transmitted to the electronic device, the stencil to be transmitted to the electronic device having a highest value of the total value parameter; transmitting, to the electronic device, the stencil to be transmitted with the associated respective set of targeted electronic messages for displaying the set of targeted electronic messages in the dedicated placement pattern.

In some implementations of the method, the selecting by the server the respective set of targeted electronic messages comprises executing a max matching optimization algorithm.

In some implementations of the method, the selecting by the server the respective set of targeted electronic messages comprises, for the each given one of the plurality of stencils: iteratively placing a given one of the plurality of candidates for the targeted electronic message for each of a placement slots of the each given one of the plurality of stencils, and selecting a given combination of the candidates for the targeted electronic message that maximizes the total value parameter, the given combination of the candidates for the targeted electronic message defining the respective set of targeted electronic messages.

In some implementations of the method, an individual value parameter for a given one of the plurality of candidates for the targeted electronic message placed on a given placement position of a given one of the plurality of stencils is determined based on at least one of: a bid value associated with a given one of the candidates for the targeted electronic message; a predicted click probability parameter; a predicted relevancy parameter; a predicted target action probability parameter; a pre-determined reserve price.

In some implementations of the method, the total value parameter is based on an amalgamation of all individual target value parameters of the set of targeted electronic messages assigned to the given one of the plurality of stencils.

In some implementations of the method, at least some of the predicted click probability parameter, the predicted relevancy parameter, the predicted target action probability parameter are determined by a Machine Learning Algorithm (MLA).

In some implementations of the method, each of the predicted click probability parameter, the predicted relevancy parameter, the predicted target action probability parameter are determined by the Machine Learning Algorithm (MLA).

In some implementations of the method, each of the predicted click probability parameter, the predicted relevancy parameter, the predicted target action probability parameter are determined by a respective Machine Learning Algorithm (MLA).

In some implementations of the method, the pre-determined reserve price is pre-determined by an operator of the server.

In some implementations of the method, the bid value associated with the given one of the candidates for the targeted electronic message is pre-determined by a source of the given one of the candidates for the targeted electronic message.

In some implementations of the method, the bid value associated with the given one of the candidates for the targeted electronic message is pre-determined by the source of the given one of the candidates for the targeted electronic message independently from other bid values pre-determines by other sources of other ones of the plurality of candidates for the targeted electronic message.

In some implementations of the method, each of the plurality of stencils is associated with a weight parameter.

In some implementations of the method, the weight parameter is representative of a displacement factor of at least some slots of the dedicated placement pattern.

In some implementations of the method, the weight parameter is further representative of a relative traffic exposure of the at least some slots of the dedicated placement pattern compared to at least some other slots of the dedicated placement pattern.

In some implementations of the method, the weight parameter is determined independently from a respective bid value associated with a given one of the plurality of candidates for the targeted electronic message.

In some implementations of the method, the weight parameter is determined prior to the receiving the request for the targeted electronic message to be transmitted to the electronic device.

In some implementations of the method, the highest value of the total value parameter is selected based on respective total value parameter of each of the plurality of stencils modified by the weight parameter.

In some implementations of the method, the respective total value parameter is determined by summing up individual values of targeted electronic messages that form the respective set of targeted electronic messages.

In some implementations of the method, the respective total value parameter is further determined by one of (i) adding the weight parameter to a sum of the individual value parameters of targeted electronic messages that form respective set of targeted electronic messages and (ii) multiplying the sum by the weight parameter.

In some implementations of the method, the weight parameter comprises a static component and a dynamic component.

In some implementations of the method, the static component is pre-determined for each of the plurality of stencils.

In some implementations of the method, the static component is pre-determined based on one of an experiment and a simulation based on a historical data.

In some implementations of the method, a respective static component is pre-determined for each of the plurality of stencils using a black box optimization algorithm.

In some implementations of the method, the respective static component is selected by the black box optimization algorithm such that to optimize a given function with a minimum threshold for an auxiliary function.

In some implementations of the method, the dynamic component is dynamically calculated for each of the plurality of stencils during the analyzing, by the server, the plurality of stencils.

In some implementations of the method, the dynamic component for a given one of the plurality of stencils is calculated as a function of at least: (i) features of the respective set of targeted electronic messages assigned to the given one of the plurality of stencils; (ii) features of the request for the targeted electronic message to be transmitted to the electronic device.

In some implementations of the method, the dynamic component is used for filtering out at least some of the plurality of stencils prior to the selecting the stencil to be transmitted.

In some implementations of the method, the selecting the stencil to be transmitted comprises selecting from a remainder of the plurality of stencils after the filtering; the selecting being done based on the static component and the dynamic component of the remainder of the plurality of stencils after the filtering.

In some implementations of the method, the method further comprises determining a respective price to be charged to a source of each of targeted electronic messages of the set of targeted electronic messages that forms part of the stencil to be transmitted of the plurality of stencils.

In some implementations of the method, the respective price is calculated based on (i) a bid value and (ii) a placement in the dedicated placement pattern of each one of the set of targeted electronic messages that forms part of the stencil to be transmitted of the plurality of stencils.

In some implementations of the method, the respective price for a given one of the set of targeted electronic messages is calculated as a function of a displacement value of the given one of the set of targeted electronic messages relative to a remainder of the set of targeted electronic messages.

In some implementations of the method, the determining the respective price (P) for a given one of the set of candidates having been assigned to the given one of the plurality of stencils comprises applying a formula:

P=V1−(TV−V1),

where

P is the respective price;

V1 is the total value of the set of candidates having been assigned to the given one of the plurality of stencils;

TV−V1 is a hypothetical total the set of candidates having been assigned to the given one of the plurality of stencils if the given one of the set of candidates was not included.

In some implementations of the method, the dedicated placement pattern comprises at least one of: a number of targeted electronic messages to be included; a relative placement on a screen of the electronic device of the targeted electronic messages included in the associated one of the plurality of stencils; a relative size of the targeted electronic messages included in the associated one of the plurality of stencils; details to be included in each of the targeted electronic messages.

In some implementations of the method, the relative placement of a given targeted electronic message is one of: above an organic search result, below the organic search result, at one side of an organic search result, as part of a search query suggest, and as part of a search result snippet.

In some implementations of the method, details include at least one of a textual description, an image, a map, a link, and a user interaction element.

In some implementations of the method, the dedicated placement pattern comprises an indication of a dynamic placement pattern for at least some of the targeted electronic messages to be included in the associated one of the plurality of stencils.

In some implementations of the method, the dynamic placement pattern comprises at least one: a sticking pattern of display of a top message of the targeted electronic messages; a repeating pattern of display of the top message of the targeted electronic messages.

In some implementations of the method, the plurality of candidates for the targeted electronic message comprises a first plurality of candidates for the targeted electronic message, and wherein the retrieving, from the databased of electronic messages, the plurality of candidates for the targeted electronic message comprises: retrieving, from the databased of electronic messages, a second plurality of candidates for the targeted electronic message; selecting the first plurality of candidates for the targeted electronic message from the second plurality of candidates for the targeted electronic message, the first plurality of candidates for the targeted electronic message being a subset of the second plurality of candidates for the targeted electronic message; the selecting being executed based on at least a relevance parameter of each of the second plurality of candidates for the targeted electronic message to the user.

In some implementations of the method, the receiving the request for the targeted electronic message to be transmitted to the electronic device is executed as part of receiving a search request, and wherein the relevance parameter is based on relevancy of each of the second plurality of candidates for the targeted electronic message to a search query submitted as part of the search request.

In some implementations of the method, the receiving the request for the targeted electronic message to be transmitted to the electronic device comprises receiving the request from the electronic device.

In some implementations of the method, the receiving the request for the targeted electronic message to be transmitted to the electronic device comprises receiving the request from an auxiliary server.

In some implementations of the method, the receiving the request for the targeted electronic message to be transmitted to the electronic device comprises generating the request by the server in response to the user requesting an access to a network resource hosted by the server.

In some implementations of the method, the targeted electronic message is an electronic ad banner.

In some implementations of the method, the targeted electronic message is a non-organic search results to be included into a Search Engine Result Page (SERP).

In some implementations of the method, the steps of:

the selecting the respective set of targeted electronic messages out of possible combinations of the plurality of candidates for the targeted electronic message; and

the selecting the given one of the plurality of stencils having been assigned the respective set of targeted electronic messages;

are both executed based on a truthfull-ness principle of electronic bid auctions.

In accordance with another broad aspect of the present technology, there is provided a server for transmitting a targeted electronic message for a user of an electronic device. The server comprises: a communication interface for communicating with the electronic device via a communication network, a processor storing computer executable instructions, which instructions when executed cause the server to: receive a request for the targeted electronic message to be transmitted to the electronic device; retrieve, from a database of electronic messages, a plurality of candidates for the targeted electronic message; retrieve a plurality of stencils, each of the plurality of stencils having a dedicated placement pattern for one or more targeted electronic messages; for each of the plurality of stencils, select a respective set of targeted electronic messages, the respective set of targeted electronic messages having one or more targeted electronic messages, the selecting being executed such that a total value parameter of the respective set of targeted electronic messages out of possible combinations of the plurality of candidates for the targeted electronic message is maximized for each given one of the plurality of stencils; analyze the plurality of stencils each having been assigned with the respective set of targeted electronic messages to select a stencil to be transmitted to the electronic device out of the plurality of stencils, the stencil to be transmitted having a highest value of the total value parameter; transmit, to the electronic device, the stencil to be transmitted with the associated respective set of targeted electronic messages for displaying the set of targeted electronic messages in the dedicated placement pattern.

In the context of the present specification, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as a electronic device in the present context is not precluded from acting as a server to other electronic devices. The use of the expression “a electronic device” does not preclude multiple electronic devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “relevance factor of the search query result set” shall mean the likelihood that the user submitting the search query was intending to see data maintained within the search query result set.

In the context of the present specification, the expression “component” is meant to include software (appropriate to a particular hardware context) that is both necessary and sufficient to achieve the specific function(s) being referenced.

In the context of the present specification, the expression a “search query result set” is a listing of results returned by a search engine, which may encompass one or more general or specialized search modules, in response to a search query. Search query result set may contain a listing of results returned by a web search module, or by one or more vertical search modules, or by combination of results returned by web module and one or more vertical modules. The search query result set may also contain no results.

In the context of the present specification, the expression a “search engine result page” is a listing of results to be displayed to a client on an electronic device, the listing generated by combining a search query result set with targeted messages.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is an illustration of a prior art system for delivering personalized content to an electronic device.

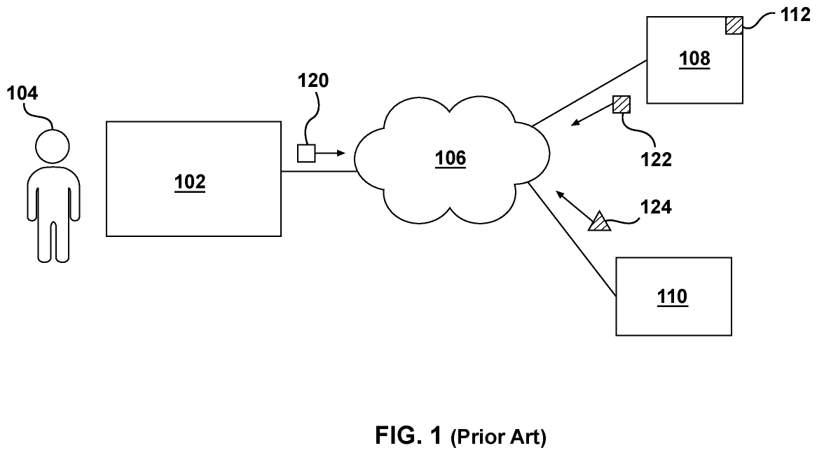

FIG. 2 depicts a diagram of a system implemented in accordance with non-limiting embodiments of the present technology.

FIG. 3 depicts an illustration of a network resource that has a generic content portion and a targeted content portion, the network resource being accessible within the system of FIG. 2.

FIG. 4 depicts an illustration of a screen shot showing a Search Engine Results Page (SERP) having search results including generic search results and targeted electronic messages, the generic search results and targeted electronic messages having been arranged to a first example of a placement pattern in accordance with the non-limiting embodiments of the present technology.

FIG. 5 depicts an illustration of a screen shot showing another SERP having search results including generic search results and targeted electronic messages, the generic search results and targeted electronic messages having been arranged to a second example of a placement pattern in accordance with the non-limiting embodiments of the present technology.

FIG. 6 depicts an illustration of a screen shot showing the SERP of FIG. 5 having search results including generic search results and targeted electronic messages, the generic search results and targeted electronic messages having been arranged to a third example of a placement pattern, the third example of the placement pattern being a dynamic placement pattern, in accordance with the non-limiting embodiments of the present technology.

FIG. 7 depicts an illustration of a screen shot showing the SERP of FIG. 6 having search results including generic search results and targeted electronic messages, the generic search results and targeted electronic messages having been arranged to a fourth example of a placement pattern, the fourth example of the placement pattern being another dynamic placement pattern, in accordance with the non-limiting embodiments of the present technology.

FIG. 8 depicts a schematic illustration of a process for selecting a subset of targeted messages to be included into a given SERP, the process being implemented in accordance with non-limiting embodiments of the present technology.

FIG. 9 depicts a schematic illustration of a plurality of candidates for the targeted electronic message, a first stencil (having a first placement slot and a second placement slot) and a second stencil (having a first placement slot and a second placement slot), as well as a step of iterative placing of the plurality of candidates for the targeted message into the various placement slots executed as part of the process of FIG. 8.

FIG. 10 depicts a block diagram of a flow chart of a method for selecting a targeted electronic message for transmission to an electronic device, the method being implemented within the system of FIG. 2 in accordance with some non-limiting embodiments of the present technology.

### DETAILED DESCRIPTION

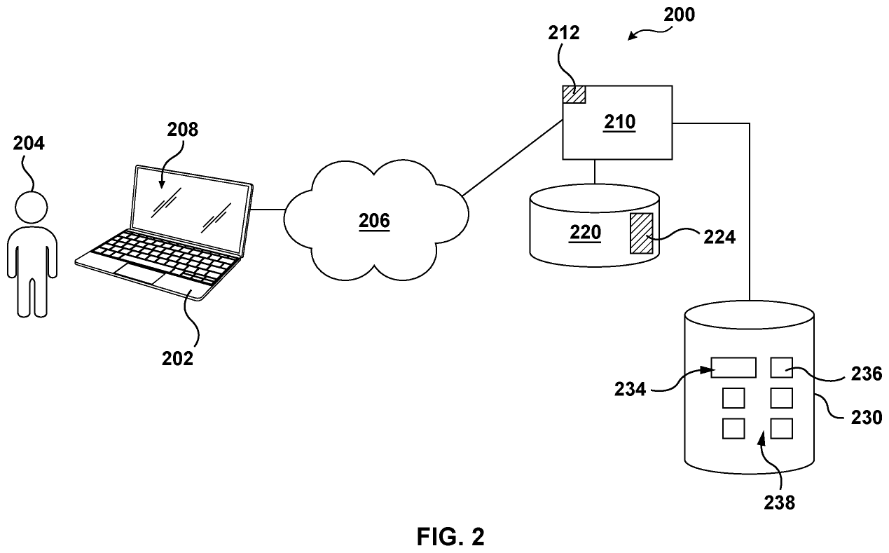

Referring to FIG. 2, there is depicted a diagram of a system 200. It is to be expressly understood that the system 200 is merely one possible implementation of the present technology. Thus, the description thereof that follows is intended to be only a description of illustrative examples of the present technology. This description is not intended to define the scope or set forth the bounds of the present technology. In some cases, what are believed to be helpful examples of modifications to system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 200 may provide in certain instances a simple implementation of the present technology, and that where such is the case they have been presented in this manner as an aid to understanding. As persons skilled in the art would understand, various implementations of the present technology may be of a greater complexity.

FIG. 2 illustrates the system 200 in accordance with one non-limiting embodiments of the present technology. The system 200 comprises an electronic device 202. The electronic device 202 is typically associated with a user 204 and, as such, can sometimes be referred to as a “client device”. It should be noted that the fact that the electronic device 202 is associated with the user does not need to suggest or imply any mode of operation—such as a need to log in, a need to be registered or the like. Naturally, the system 200 can have a plurality of electronic devices similar or different from the electronic device 202.

The implementation of the electronic device 202 is not particularly limited, but as an example, the electronic device 202 may be implemented as a personal computer (desktops, laptops, netbooks, etc.), a wireless electronic device (a cell phone, a smartphone, a tablet and the like), as well as network equipment (a router, a switch, or a gateway).

The general implementation of the electronic device 202 is known in the art and, as such, will not be described here at much length. Suffice it to say that the electronic device 202 comprises a user input interface (such as a keyboard, a mouse, a touch pad, a touch screen and the like) for receiving user inputs; a user output interface (such as a screen, a touch screen, a printer and the like) for providing visual or audible outputs to the user 204; a network communication interface (such as a modem, a network card and the like) for two-way communication over a communication network 206; and a processor coupled to the user input interface, the user output interface and the network communication interface, the processor being configured to execute various routines, including those described herein below. To that end the processor may store or have access to computer readable commands which commands, when executed, cause the processor to execute the various routines described herein.

The electronic device 202 comprises hardware and/or software and/or firmware (or a combination thereof) that enable the electronic device 202 to execute a browser application 208. Generally speaking, the purpose of the browser application 208 is to enable the user 204 to access one or more network resources via the communication network 206, such as a network resource 212 hosted by a network resource server 210. In a specific non-limiting embodiment of the present technology, the network resource 212 can be a search engine and the network resource server 210 can be a search engine server.

However, it should be noted that even though non-limiting embodiments of the present technology can be applied to other types of network resource 212 and/or other types of network resource server 210. Broadly speaking, non-limiting embodiments can be implemented to any type of network resource 212 that provides targeted electronic messages that are selected based on auction principles, as has been alluded to above.

Furthermore, the system 200 comprises the above-mentioned communication network 206. In some non-limiting embodiments of the present technology, the communication network 206 can be implemented as the Internet. In other embodiments of the present technology, the communication network 206 can be implemented differently, such as any wide-area communications network, local-area communications network, a private communications network and the like.

The system 100 further comprises the above-mentioned network resource server 210 coupled to the communication network 206 via a communication link (not separately numbered). The network resource server 210 can be implemented as a conventional computer server. In an example of an embodiment of the present technology, the network resource server 210 can be implemented as a Dell™ PowerEdge™ Server running the Microsoft™ Windows Server™ operating system. Needless to say, the network resource server 210 can be implemented in any other suitable hardware and/or software and/or firmware or a combination thereof. In the depicted non-limiting embodiment of present technology, the network resource server 210 is a single server. In alternative non-limiting embodiments of the present technology, the functionality of the network resource server 210 may be distributed and may be implemented via multiple servers.

Briefly speaking, the network resource server 210 comprises a communication interface (not depicted) structured and configured to communicate with various entities (such as the electronic device 102, for example and other devices potentially coupled to the communication network 206) via the communication network 206. The network resource server 210 further comprises at least one computer processor (not depicted) operationally connected with the communication interface and structured and configured to execute various processes to be described herein.

The network resource server 210 is configured to provide access to a plurality of network resources, one of which, the network resource 212 is depicted in FIG. 2. The network resource 212 can be accessed by the user 204 using the electronic device 202 in a number of ways, such as by entering an URL associated with the network resource 212 into the browser application 208 executed by the electronic device 202, by clicking a link (such as one in an e-mail, another network resource or on a search engine result page) directed to the network resource 212 or by any other suitable means.

As has been alluded to above the network resource 212 can be a search engine/search engine result page, but can also be a web site, a web portal, a search result page, or the like.

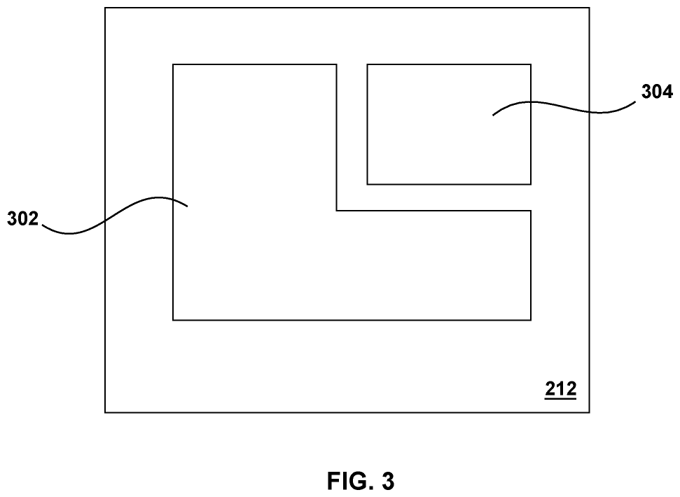

With reference to FIG. 3, there is depicted a schematic representation of a content of the network resource 212. The network resource 212 has a generic content portion 302 and a targeted content portion 304. In the embodiments described herein, the generic content portion 302 comprises a portion of a Search Engine Results Page (SERP) that contains results ranked using an “organic” ranking algorithm of the search engine server. These can be documents available on the Internet or documents found on the various verticals (such as images, maps, movies, and the like). The targeted content portion 304 comprises content that is specifically targeted for the given user (such as the user 204). The targeted content portion 304 can include search results that have been “promoted” on a special placement, electronic ad banners, and the like.

However, broadly speaking in other embodiments of the present technology, it can be said that the generic content portion 302 comprises content that that would be shown to any user accessing the network resource 212 without taking into account user-specific parameters, such as user interests, user interaction history and the like. Targeted content portion 304 comprises content that is specifically personalized (i.e. selected) for the given user (such as the user 204), based on predicted or known user interest parameters.

For example, for a newspaper portal being the network resource 212, the generic content portion 302 can contain top news that would be shown to any user accessing the newspaper portal, while the targeted content portion 304 can include news associated with a specific topic of interest for the user 204 (i.e. the targeted content portion 304 can have a selection of news specifically selected for a given user, such as the user 204. By the same token, the targeted content portion 304, in the same newspaper portal example, can include a targeted message, such as an ad that is specifically selected for the user 204.

Even though the illustration of FIG. 3 schematically shows a single instance of the generic content portion 302 and a single instance of the targeted content portion 304, this needs not be so in every embodiment of the present technology. As such, it is contemplated that the network resource 212 can have one or more instances of the generic content portion 302 and one or more instances of the targeted content portion 304.

It should also be noted that the placement of the one or more instances of the generic content portion 302 and one or more instances of the targeted content portion 304 is not particularly limited.

In some embodiments, some or all of the targeted content portion 304 can be visually distinguished from one or more instances of one or more instances of the generic content portion 302. In these embodiments, any one of the targeted content portion 304 can be located above, below, to the right or to the left of any one or more instances of one or more instances of the generic content portion 302. In some of these embodiments, any one of the targeted content portion 304 can be located in-between any two of the one or more instances of one or more instances of the generic content portion 302 (but still be visually distinguishable—such as by a different appearance, font, color, border or the like).

In other embodiments, some or all of the targeted content portion 304 can be visually non-distinguishable from one or more instances of one or more instances of the generic content portion 302. In these embodiments, any one of the targeted content portion 304 can be located in-between any two of the one or more instances of one or more instances of the generic content portion. This is a particularly applicable approach for those embodiments (without being so limited) where the network resource 212 is a search engine result page and the generic content portion 302 presents search results ranked in accordance with a generic ranking algorithm, while the targeted content portion 304 presents search results that are ranked in accordance with user-personalized or rank-promotional ranking algorithm.

In accordance with the non-limiting embodiments of the present technology, the network resource server 210 has access to a plurality of stencils 224 stored in a stencil database 220, as depicted in FIG. 2. Broadly speaking, each of the plurality of stencils 224 is associated with a dedicated placement pattern for one or more targeted electronic messages to be displayed in the browser application 208 as part of displaying the network resource 212 requested by the electronic device 202.

In accordance with the non-limiting embodiments of the present technology, the number of the plurality of stencils 224 can be pre-determined. As an example, the number of the plurality of stencils 224 can be ten, twenty, forty five, or any other suitable number, as determined by an operator of the network resource 212.

In accordance with the non-limiting embodiments of the present technology, the dedicated placement pattern comprises at least one of: a number of targeted electronic messages to be included; a relative placement on a screen of the electronic device 202 of the targeted electronic messages included in the associated one of the plurality of stencils; a relative size of the targeted electronic messages included in the associated one of the plurality of stencils; the amount of details to be included in each of the targeted electronic messages, or a combination thereof.

In various non-limiting embodiments of the present technology, the relative placement of a given targeted electronic message is one of: above an organic search result, below the organic search result, at one side of an organic search result, as part of a search query suggest, and as part of a search result snippet.

In yet further non-limiting embodiments of the present technology, the dedicated placement pattern comprises an indication of a dynamic placement pattern for at least some of the targeted electronic messages to be included in the associated one of the plurality of stencils 224. The dynamic placement pattern may be one of: a sticking pattern of display of a top message of the targeted electronic messages; a repeating pattern of display of the top message of the targeted electronic messages, or a combination thereof.

The various non-limiting examples of the dedicated placement patterns that can be defined by the plurality of stencils 224 will now be described.

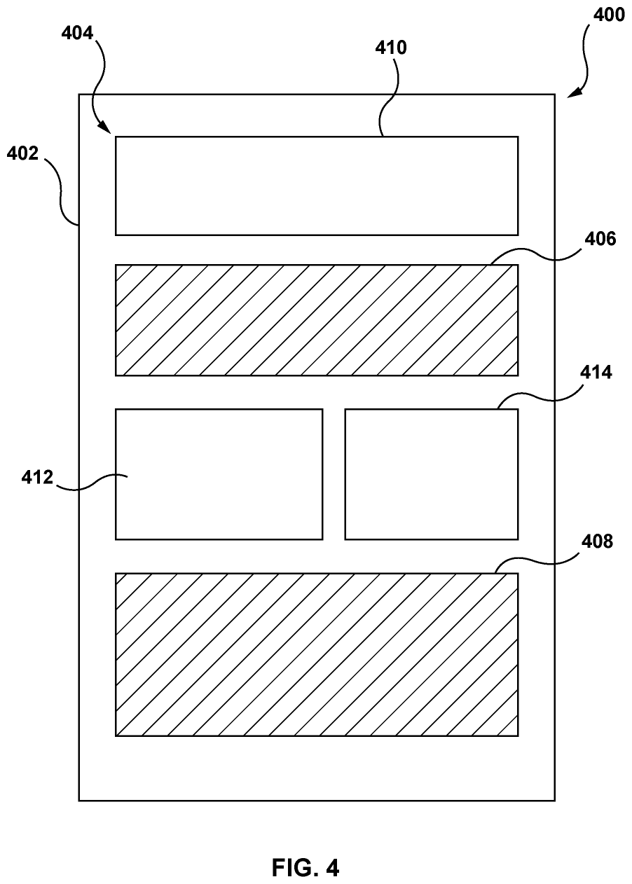

With reference to FIG. 4, there is depicted a first example of a screen shot 400. The screen shot 400 depicts the network resource 212 in a form of a SERP 402 displayed on a screen of the electronic device 202. The SERP 402 comprises a plurality of search results 404. The network resource 212 has generated the plurality of search results 404 in response to a search query received form the electronic device 202, the search query including at least one search terms representative of the search intent of the user 204.

The plurality of search results 404 includes a first organic search result 406 and a second organic search result 408, both depicted in FIG. 4 in solid black color. The plurality of search results 404 further includes a set of targeted messages, namely a first targeted electronic message 410, a second targeted electronic message 412 and a third targeted electronic message 414. The first targeted electronic message 410, the second targeted electronic message 412 and the third targeted electronic message 414 have been arranged in the placement pattern that is prescribed by an associated one of the plurality of stencils 224.

In this example, the placement pattern prescribes a number of targeted electronic messages to be included, namely three targeted messages (the first targeted electronic message 410, the second targeted electronic message 412 and the third targeted electronic message 414).

The placement pattern further prescribes a relative positioning of targeted electronic messages to be included (the first targeted electronic message 410, the second targeted electronic message 412 and the third targeted electronic message 414).

In this example, a top targeted electronic message (the first targeted electronic message 410) is placed at the very top of the SERP 402, above any organic search results. The other two targeted electronic messages (the second targeted electronic message 412 and the third targeted electronic message 414) are placed together and are inter-meshed with organic search results (namely, positioned between the first organic search result 406 and the second organic search result 408.

The placement pattern further prescribes relative size of the targeted electronic messages to be included (the first targeted electronic message 410, the second targeted electronic message 412 and the third targeted electronic message 414). In this example, a top targeted electronic message (the first targeted electronic message 410) is sized relatively larger compared to the other two targeted electronic messages (the second targeted electronic message 412 and the third targeted electronic message 414).

In this example, the second targeted electronic message 412 and the third targeted electronic message 414 are sized similarly therebetween, but smaller than the first targeted electronic message 410. It is also noted that the size of the first targeted electronic message 410 is generally similar to the organic search results (the first organic search result 406 and the second organic search result 408).

It should be noted that the above description is provided for illustrative purposes only. As such, the number of generic search results, the number of targeted electronic messages, the placement and the sizing of the generic search results and the targeted electronic messages can vary.

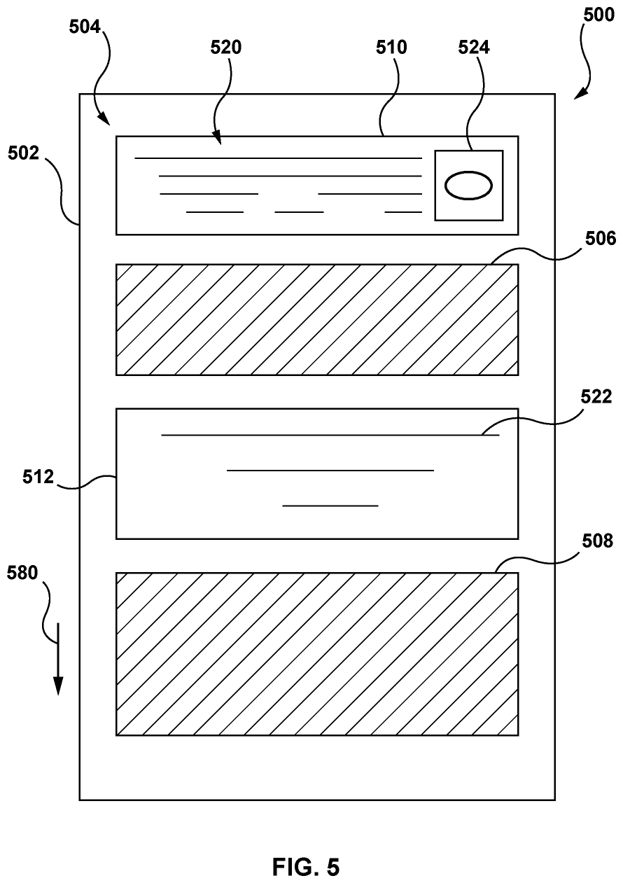

With reference to FIG. 5, there is depicted a second example of a screenshot 500. The screenshot 500 depicts the network resource 212 in a form of a SERP 502 displayed on a screen of the electronic device 202. The SERP 402 comprises a plurality of search results 504. The network resource 212 has generated the plurality of search results 504 in response to a search query received form the electronic device 202, the search query including at least one search terms representative of the search intent of the user 204.

The plurality of search results 504 includes a first organic search result 506 and a second organic search result 508, both depicted in FIG. 4 in solid black color. The plurality of search results 504 further includes a set of targeted messages, namely a first targeted electronic message 510 and a second targeted electronic message 512. The first targeted electronic message 510 and the second targeted electronic message 512 have been arranged in the placement pattern that is prescribed by another associated one of the plurality of stencils 224.

In this example, the placement pattern prescribes a number of targeted electronic messages to be included, namely two targeted messages (the first targeted electronic message 510 and the second targeted electronic message 512.

The placement pattern further prescribes a relative positioning of targeted electronic messages to be included (the first targeted electronic message 510 and the second targeted electronic message 512). In this example, a top targeted electronic message (the first targeted electronic message 510) is placed at the very top of the SERP 402, above any organic search results. The other targeted electronic messages (the second targeted electronic message 512) is inter-meshed with organic search results (namely, positioned between the first organic search result 506 and the second organic search result 508).

The placement pattern further prescribes relative size of the targeted electronic messages to be included (the first targeted electronic message 510 and the second targeted electronic message 512). In this example, a top targeted electronic message (the first targeted electronic message 510) is sized the sane as the other targeted electronic message (the second targeted electronic message 512).

It is also noted that the size of the first targeted electronic message 510 and the second targeted electronic message 512 is generally similar to the organic search results (the first organic search result 506 and the second organic search result 508).

In this alternative example, the placement pattern further prescribed the amount of details to be included in the targeted electronic messages (i.e. the first targeted electronic message 510 and the second targeted electronic message 512). In the illustrated example, the first targeted electronic message 510 comprises a set of details 520 and the second targeted electronic message 512 comprises a set of details 522. It can be seen, the set of details 520 is larger than the set of details 522. In the illustrated example, the first targeted electronic message 510 further includes an image 524, which is not present in the second targeted electronic message 512.

Examples of various elements that can form part of the first set of details 520 (or the second set of details 522) include but are not limited to: Unified Resource Locator, a textual snippet, representative links, quick access links, address, other contact information, etc. The image 524 can be a representative image from the associate resource, a map, and the like.

Now, we will turn our attention to illustration of dynamic placement patterns. As can be appreciated, the SERP 502 has many more search results than the four shown in FIG. 5. Thus, the user 104 can scroll the display in a direction 580, thus revealing additional search results that are not visible in the screenshot 500. Conventionally, as the user 104 scrolls, the search result visible in FIG. 5 would sequentially “disappear” in a direction opposite to the direction 580, while new search results would sequentially appear.

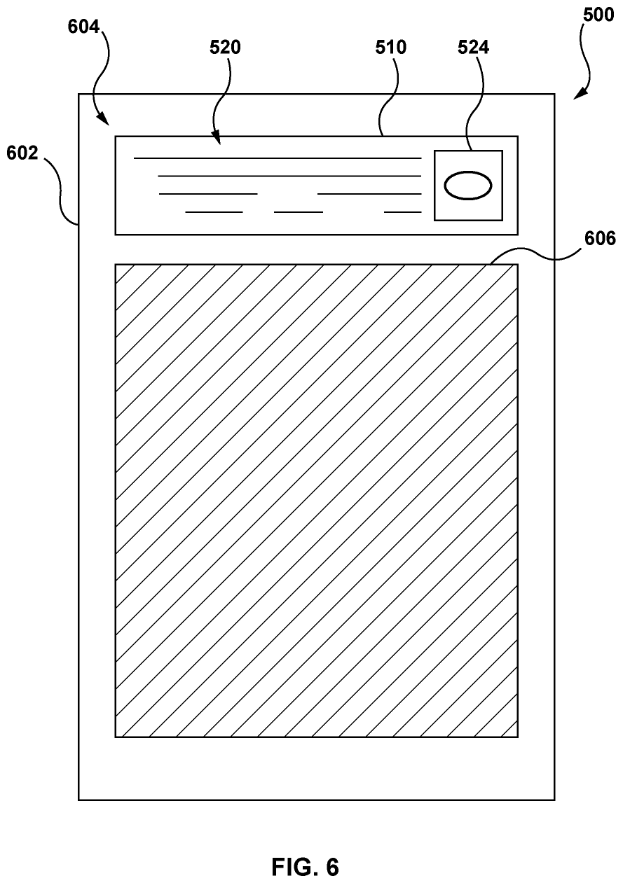

In accordance with the non-limiting embodiments, a given one of the plurality of stencils 224 may prescribe a dynamic placement pattern in a form of a sticking pattern. In this example, the top result (in this case the first targeted electronic message 510) would “stick” at the top of the SERP 502 even as the user 104 scrolls down in the direction 580. This is depicted in FIG. 6, which depicts the screenshot 500 with a SERP 602 having an updated plurality of search results 604, which represent a version of the SERP 502 after the user 104 has scrolled down.

As can be appreciated from FIG. 6, the SERP 602 now depicts the first targeted electronic message 510 at a top position, with a set of new organic search results 606. It is noted that as the user 104 keeps scrolling, the first targeted electronic message 510 can remain at the top of the SERP 602 as further additional search results are presented to the user 204.

Also, it should be noted that even thought that even though FIG. 6 illustrates the SERP 602 having the set of new organic search results 606, the SERP 602 can also have additional targeted electronic messages inter-meshed within the set of new organic search results 606.

Another dynamic placement pattern may prescribe a repeating pattern of displaying of the top targeted electronic message (in this case the first targeted electronic message 510).

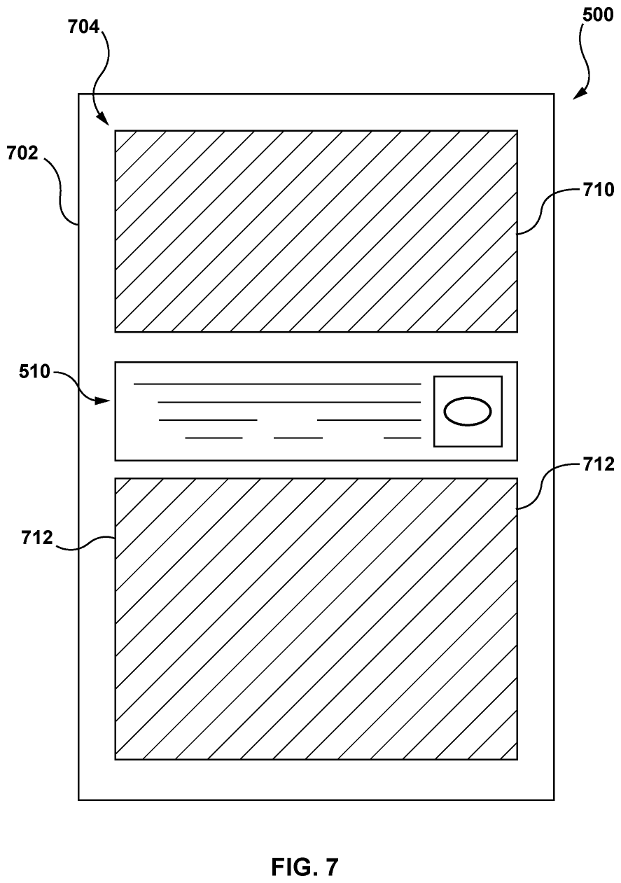

This is depicted in FIG. 7, which depicts the screenshot 500 with a SERP 702 having an updated plurality of search results 704, which represent a version of the SERP 502 after the user 104 has scrolled further down compared to the SERP 602.

As can be appreciated from FIG. 7, the SERP 702 now depicts the first targeted electronic message 510 inter-meshed, with a first set of organic search results 710 and a second set of organic search results 712. It is noted that as the user 104 keeps scrolling, the first targeted electronic message 510 will disappear in further sets of organic search results. On other words, in these embodiments, the top targeted electronic message can be “re-shown” (one or more times) to the user 104 as the user 104 scrolls through the search results.

It should be noted that various examples of the placement patterns prescribed by the plurality of stencils 224 have been provided as illustrative examples only. Other types of placement patterns are also envisioned. It is also envisioned that various elements of the placement patterns can be mixed and matched.

Given the various examples provided above, it is now clear that various placement patterns provide different “exposure” to different targeted electronic messages included into the set of electronic messages. Taking the example of FIG. 4, the first targeted electronic message 410 has a higher exposure compared to the second targeted electronic message 412 and the third targeted electronic message 414. This increased exposure is achieved at least based on higher (i.e. more prominent) placement and a larger size compared to other targeted electronic messages.

Taking example of FIG. 5, the first targeted electronic message 510 has high exposure than the second targeted electronic message 512. This higher exposure is achieved at least based on a higher (i.e. more prominent) placement and more details included in the first targeted electronic message 510.

At least some non-limiting embodiments of the present technology are based on the realization by developers thereof that higher exposure may result in higher traffic associated with the targeted electronic message. In other words, the more exposure a given targeted electronic message has, the more likely the user 104 is to perform a desired action with the given targeted electronic message. The desired action may be, but is not limited to, a click on the given targeted electronic message, an action executed on a resource that is to be presented upon the user 104 clicking the given targeted electronic message, etc.

Recalling that at least some of the non-limiting embodiments are implemented in an environment where targeted electronic messages are selected based on an auction principle, where the targeted electronic messages are selected as a function of at least a bid value associated with the given targeted electronic message, it is noted that the bid value of the given targeted electronic message is provided by a source of the given targeted electronic message and generally represents the price that the source is willing to pay for an exposure event of the given targeted electronic message. The exposure event may include the given targeted electronic message being shown to a user (such as the user 104) or the user 104 clicking (or otherwise interacting) with the given targeted electronic message.

At least some non-limiting embodiments of the present technology are based on the premise that a given source of the given targeted electronic message sets the bid value independently of other sources of other targeted electronic messages. In other words, at least some non-limiting embodiments of the present technology are based on the premise that the source of the given targeted electronic message sets the bid value based on various considerations specific to the source (such as financial considerations, competitive landscape in which the source operates. other commercial considerations, and the like).

It is also noted that at least some of the non-limiting embodiments of the present technology, the targeted electronic messages are selected based on truthfull-ness principle of electronic bid auctions. In other words, the selection of the targeted electronic messages is done such that to be fair to the source of the targeted electronic message, the user 104 and the auction platform (such as the network resource 212). At least some non-limiting embodiments of the present technology are based on the presumption that if the targeted electronic messages are selected based on the truthfull-ness principle of electronic bid auctions, the sources of the targeted electronic messages will be “truthful” when selecting their respective bid value.

Thus, in accordance with the non-limiting embodiments of the present technology, each of the plurality of stencils 224 can be associated with a weight parameter. In some non-limiting embodiments of the present technology, the pre-determined weight parameter is representative of a displacement factor of at least some slots of the dedicated placement pattern.

For example, taking an example of FIG. 4, the first targeted electronic message 410 has a higher exposure compared to the second targeted electronic message 412 and the third targeted electronic message 414. Thus, the first targeted electronic message 410 will displace a comparatively higher traffic. In other words, the first targeted electronic message 410 is likely to get more traffic than the second targeted electronic message 412 and the third targeted electronic message 414. Now, imagine the SERP 402 did not have the first targeted electronic message 410 and only the second targeted electronic message 412 and the third targeted electronic message 414. In that hypothetical scenario, the displacement value would be lower, as the second targeted electronic message 412 and the third targeted electronic message 414 are likely to have lower exposure than the first targeted electronic message 410.

Thus, it can be said that the pre-determined weight parameter is further representative of a relative traffic exposure of the at least some slots of the dedicated placement pattern compared to at least some other slots of the dedicated placement pattern.

In accordance with the non-limiting embodiments of the present technology, the pre-determined weight parameter is determined prior to execution of the methods that will be described herein. It is noted that the pre-determined weight parameter is determined independently from a bid value associated with the plurality of candidates for the targeted electronic message.

As will be described in greater detail herein below, the weight parameter is used to determine the highest value of the total value parameter for each of the plurality of stencils 224, which in turn is used to select which of the plurality of stencils 224 to use.

Returning to the description of FIG. 2, the system 200 further comprises targeted electronic messages database 230. The targeted electronic messages database 230 stores a plurality of targeted electronic messages 238. In accordance with the non-limiting embodiments of the present technology, the plurality of targeted electronic messages 238 can be thought of as a plurality of candidates for the targeted electronic message to be transmitted to the electronic device 202.

The plurality of targeted electronic messages 238 may have been provisioned by a plurality of respective sources (not depicted) of the plurality of targeted electronic messages 238. To this end, each source who is interested in having their targeted electronic message top be provided by the network resource 212, may have provisioned a body of the targeted electronic message 234 and a bid value 236. The body of the targeted electronic message 234 includes all the information that can be potentially presented to the user 204, depending on a specific one of the plurality of stencils 224 used. The body of the targeted electronic message 234 may also include a targeting pattern, i.e. an indication of properties or characteristics of the user 204 to whom the associated targeted electronic message is to be presented.

In accordance with the non-limiting embodiments of the present technology, a process for selecting a subset of targeted messages to be included in a given impression generated by the network resource 212 will not be described. The example to be presented below will be based on the network resource 212 being a search engine configured to generate SERPs in response to user's submitted search queries.

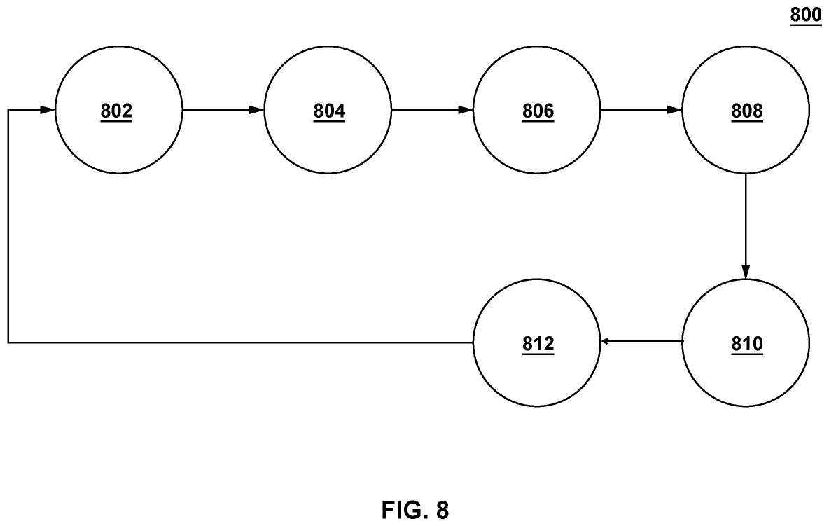

As such, with reference to FIG. 8, there is depicted a process 800 for selecting a subset of targeted messages to be included into a given SERP.

Triggering Targeted Electronic Message(s) Selection Process

The process 800 starts with a sub-process 802, where the network resource 212 receives a request for the targeted electronic message to be transmitted to the electronic device 202. In this illustration, the request comes as part of a search query submitted by the user 214, the search query having one or more search terms that represent search intent of the user 204. The search intent can be anything and represented in free-form search request typed in by the user 204, for example “Cheap flights from Paris to Nice” or “Latest news about fire of Notre Dame de Paris”.

However, it alternative embodiments of the present technology, the sub-process 802 may be implemented differently.

For example, the receiving the request for the targeted electronic message to be transmitted to the electronic device 202 can be implemented as receiving the request from an auxiliary server (such as an auxiliary ad platform or the like).

In yet further embodiments, the receiving the request for the targeted electronic message to be transmitted to the electronic device 202 can be implemented as the network resource 212 generating the request by itself simply in response to the user 204 requesting an access to the network resource 212 (for example, by accessing its URL).

Selecting Candidates for the Targeted Electronic Message(s)

Then, at sub-process 804, the network resource 212 retrieves, from the plurality of targeted electronic messages 238, a plurality of candidates for the targeted electronic message.

In some non-limiting embodiments of the present technology, the network resource 212 retrieves and further processes (as will be described herein below) the totality of the plurality of targeted electronic messages 238 stored in the targeted electronic messages database 230.

In other non-limiting embodiments of the present technology, the network resource 212 retrieves the plurality of targeted electronic messages 238 from the targeted electronic messages database 230 and performs filtering thereof for further processing.

In some non-limiting embodiments of the present technology, the filtering is done such that to select a subset of the plurality of candidates for the targeted electronic message. In some embodiment such selecting is executed based on at least a relevance parameter of each of the second plurality of candidates for the targeted electronic message to the user. This selection can be done based on a user profile associated with each of the users, the user profile denoting user's interest and socio-economic or demographic characteristics.

In other embodiments of the present technology, especially but not exclusively applicable where the receiving the request for the targeted electronic message to be transmitted to the electronic device is executed as part of receiving a search request, and the relevance parameter is based on relevancy of each of the subset of the plurality of candidates for the targeted electronic message to a search query submitted as part of the search request.

Selecting a Sub-Set of Targeted Electronic Messages for Each of the Plurality of Stencils 224

Then, at sub-process 806, the network resource 212 retrieves from the stencil database 220 the plurality of stencils 224, each of the plurality of stencils 224 having the associated dedicated placement pattern for one or more targeted electronic messages (example of which were discussed above with reference to FIGS. 4-7).

As part of sub-process 806, the network resource 212, for each of the plurality of stencils 224, selects a respective set of targeted electronic messages, the respective set of targeted electronic messages having one or more targeted electronic messages. Broadly speaking, the selection of the one or more targeted electronic messages for each of the plurality of stencils 224 is executed such that a total value parameter of the respective set of targeted electronic messages out of possible combinations of the plurality of candidates for the targeted electronic message is maximized for each given one of the plurality of stencils.

In some embodiments of the present technology, the selecting the respective set of targeted electronic messages comprises executing a max matching optimization algorithm. This algorithm is also known as assignment problem or generalized assignment problem. This optimization task is analogous to what is also used for assigning workers to various work tasks. Various methods for solving this optimization tasks are known, such as the Hungarian algorithm, also known as Kuhn-Munkres algorithm or Munkres assignment algorithm.

More specifically, the selecting the respective set of targeted electronic messages comprises, for the each given one of the plurality of stencils 224: iteratively placing a given one of the plurality of candidates for the targeted electronic message for each of a placement slots of the each given one of the plurality of stencils 224, and selecting a given combination of the candidates for the targeted electronic message that maximizes the total value parameter, the given combination of the candidates for the targeted electronic message defining the respective set of targeted electronic messages.

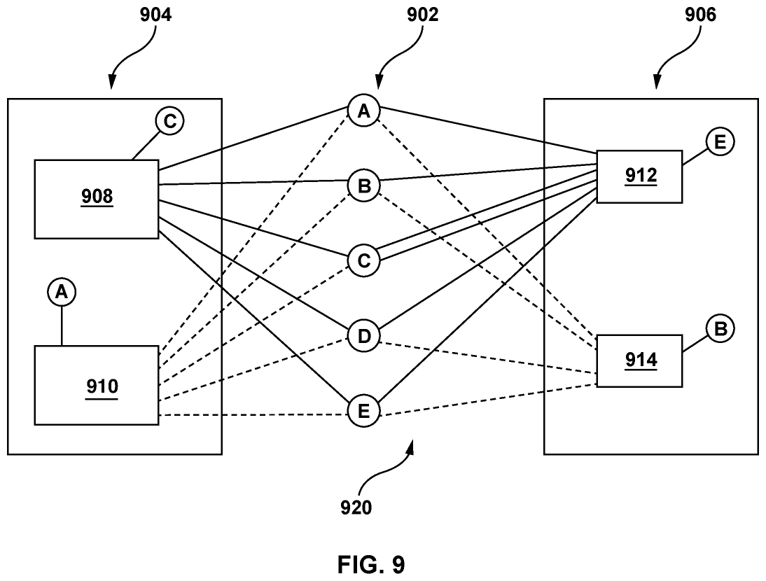

This process is schematically shown in FIG. 9, which illustrates a plurality of candidate plurality of candidates for the targeted electronic message 902, a first stencil 904 (having a first placement slot 908 and a second placement slot 910) and a second stencil 906 (having a first placement slot 912 and a second placement slot 914). The process of iterative placing is depicted by lines 920 (some are depicted as solid and some as dotted for ease of illustration).

In some non-limiting embodiments of the present technology, an individual value parameter of a given targeted electronic messaged placed on a given placement position of a given stencil of a plurality of stencils 224 is calculated based on at least some of:
a bid value associated with a given one of the candidates for the targeted electronic message;
a predicted click probability parameter;
a predicted relevancy parameter;
a predicted target action probability parameter;
a pre-determined reserve price.

The predicted click probability parameter (or CTR for short) can be a raw value of the predicted parameter or calculated as a function of the predicted parameter (such as the predicted parameter modified with a weight, an additive parameter, or another function).

In some non-limiting embodiments of the present technology, at least some of the predicted click probability parameter, the predicted relevancy parameter, the predicted target action probability parameter are determined by a Machine Learning Algorithm (MLA). In some non-limiting embodiments of the present technology, each of the predicted click probability parameter, the predicted relevancy parameter, the predicted target action probability parameter are determined by the Machine Learning Algorithm (MLA).

In some non-limiting embodiments of the present technology, each of the predicted click probability parameter, the predicted relevancy parameter, and the predicted target action probability parameter are determined by a respective Machine Learning Algorithm (MLA).

In some non-limiting embodiments of the present technology, the pre-determined reserve price is pre-determined by an operator of the server.

In some non-limiting embodiments of the present technology, the bid value associated with the given one of the candidates for the targeted electronic message is pre-determined by a source of the given one of the candidates for the targeted electronic message. In some non-limiting embodiments of the present technology, the bid value associated with the given one of the candidates for the targeted electronic message is pre-determined by the source of the given one of the candidates for the targeted electronic message independently from other bid values pre-determines by other sources of other ones of the plurality of candidates for the targeted electronic message.

In some non-limiting embodiments of the present technology, the predicted click probability parameter is predicted by a trained MLA based on a plurality of factors, which factors may include historical data from past biddings, features of the given candidate for the targeted electronic message, and the like.

In some non-limiting embodiments of the present technology, the predicted relevancy parameter is predicted by a trained MLA based on a plurality of factors of the candidate for the targeted electronic message and/or the user 204. These features may include interest profile of the user 204, socio-demographic parameters of the user 204, browsing history of the user 204, search history of the user 204, and the like.

In some non-limiting embodiments of the present technology, the predicted target action probability parameter is predicted by a trained MLA. The predicted target action probability parameter can be a conversion parameter. The conversion parameter is indicative of a likelihood of the user 204 executing a desired target action if the user 204 is exposed to the given candidate for the targeted electronic message.

In some non-limiting embodiments of the present technology, the total value parameter (TVP) is determined by amalgamating all or as a function of the set of targeted electronic messaged that got assigned to a given stencil.

In the specific example illustrated in FIG. 9, as a result of executing the sub-process 806, the following sets of targeted electronic messages have been determined:

For the first stencil 904:
the first placement slot 908 having been assigned with the targeted electronic message C
the second placement slot 910 having been assigned with the targeted electronic message A

For the second stencil 906:
the first placement slot 912 having been assigned with the targeted electronic message E
the second placement slot 914 having been assigned with the targeted electronic message B

It is noted that in accordance with non-limiting embodiments, the calculation of the individual value parameters can be based on a linear function based on the bid value. It is noted that in at least some embodiments of the present technology, the linear coefficient is independent from the bid value.

As such, the calculation of the individual value parameters can be based on a linear function expressed as, in at least some non-limiting embodiments of the present technology as:

VP=A*t+B Equation 1

where

the VP is the individual value parameter;

A is a predicted CTR or, broadly speaking, can be calculated as a function of the CTR;

t is the bid value;

B is a linear coefficient, which is independent from the bid value.

The linear coefficient can be based on one or more of: a predicted click probability parameter;

a predicted relevancy parameter;

a predicted target action probability parameter;

a pre-determined reserve price.

In some non-limiting embodiments of the present technology, the total value parameter of the respective set of targeted electronic messages out of possible combinations of the plurality of candidates for the targeted electronic message is calculated a sum of value parameters of each individual targeted electronic message places at a given placement slot of the given one of the plurality of stencils. In other words, it can be said that the given targeted electronic message is selected for a given placement slot of a given one of the plurality of stencils 224 based on a “local” maximization of the value parameter.

Selecting a Winning One of the Plurality of Stencils 224

Then, at sub-process 808, the network resource 212 analyzes the plurality of stencils 224 each having been assigned with the respective set of targeted electronic messages to select a winning one of the plurality of stencils, the winning one of the plurality of stencils having a highest value of the total value parameter. In accordance with the non-limiting embodiments of the present technology the winning one of the plurality of stencils can be also thought of and can be referred to as “a stencils to be transmitted to the electronic device 202”, as selected by the processes and methods described herein.

It should be recalled that each one of the plurality of stencils 224 is associated with a weight parameter. As such, in at least some non-limiting embodiments of the present technology, the highest value of the total value parameter is selected based on respective total value parameter of each of the plurality of stencils modified by the weight parameter.

More specifically, in some non-limiting implementations of the method, the respective total value parameter is determined by summing up individual value parameters of targeted electronic messages that form the respective set of targeted electronic messages. and (ii) multiplying a sum by the weight parameter. In some non-limiting embodiments of the present technology, the respective total value parameter is further determined by one of (i) adding the weight parameter to a sum of the individual values of targeted electronic messages that form the respective set of targeted electronic messages and (ii) multiplying the sum by the weight parameter.

In alternative non-limiting embodiments of the present technology, the weight parameter comprises a static component (C) and a dynamic component (q).

In accordance with the non-limiting embodiments of the present technology, the static component (C) can be pre-determined for each of the plurality of stencils 224. As an example, a respective static component (C) can be pre-determined for each one of the plurality of stencils 224 using a black box optimization algorithm. In some alternative non-limiting embodiments of the present technology, the static component is pre-determined based on one of an experiment and a simulation based on a historical data.

Within these non-limiting embodiments of the present technology, the respective static component (C) can be selected by the black box optimization algorithm such that to optimize a given function with a minimum threshold for an auxiliary function. For example, the given function can be revenue to be received by the operator of the network resource 212, while the auxiliary function can be satisfaction of the user 204 and/or minimum exposure to the source of the given one of the targeted electronic messages. Naturally, it is possible to reverse the given function and the auxiliary function.

The dynamic component can be dynamically calculated for each of the plurality of stencils 224 during the analyzing the plurality of stencils 224 having been assigned the set of targeted electronic messages to select the wining one.

The dynamic component for a given one of the plurality of stencils 224 is calculated as a function of at least: (i) features of the respective set of targeted electronic messages assigned to the given one of the plurality of stencils 224; (ii) features of the request for the targeted electronic message to be transmitted to the electronic device.

Taking an example of FIG. 6, let it be assumed that the image 524 is a map. In this example, the features analyzed can be whether or not the request for the targeted message has a geo-intent. Additionally, features of the electronic device 202 can be considered, such as a current location, a typical location, and the like. Additionally, features of the electronic targeted message source can be considered, for example, how close the location of the source is to the current or the typical location of the user is. For those sources that have multiple locations (such as a chain coffee shop), a selection of the map of the closest one to the current location of the typical location of the user 204 can be executed.

In those examples where the image 524 is a representative image of the network resource associated with the source of the targeted electronic message, the features considered can include relevancy of the image content to the search query (which was submitted as part of the request), quality of the image (using image recognition or other electronic image analysis means), and the like.

It is noted that the dynamic component (q) is calculated for the set of the targeted electronic messages having been assigned to the given one of the plurality of stencils 224 as a whole. In other words, the dynamic component (q) can be said to be representative of a global value parameter of the set of the targeted electronic messages having been assigned to the given one of the plurality of stencils 224.

In some non-limiting embodiments of the present technology, the dynamic component (q) is calculated by a trained MLA, which MLA has been trained on labeled sets of SERPs. The SERPs may have been labelled by assessors based on a task statement: “For this search request, for this SERP—does it make sense to include a map?”.

In some non-limiting embodiments of the present technology, the dynamic component is used for filtering out at least some of the plurality of stencils 224 prior to the selecting the winning one of the plurality of stencils 224. In some non-limiting embodiments of the present technology, the dynamic component can be compared to a pre-determined threshold and those ones of the plurality of stencils 224 falling under the pre-determined threshold can be filtered out from further processing. In some embodiments of the present technology, the pre-determined threshold is selected such as to filter out those ones of the plurality of stencils 224 that have poor global value parameter of the set of targeted messages assigned to the given one of the plurality of stencils 224, as a whole.

In these embodiments of the present technology, the selecting the winning one of the plurality of stencils 224 comprises selecting from a remainder of the plurality of stencils 224 after the filtering; the selecting being done based on the static component (C) and the dynamic component (q) of the remainder of the plurality of stencils 224 after the filtering.

Transmitting the Winning One of the Plurality of Stencils 224 and the Associated Subset of Targeted Electronic Messages to the Electronic Device 202

Then, at sub-process 810, the network resource 212 transmits, to the electronic device 202, the winning one of the plurality of stencils having the highest total value with the associated respective set of targeted electronic messages for displaying the set of targeted electronic messages in the dedicated placement pattern. The various possible non-limiting examples of such displaying have been discussed above with the aid of screenshots depicted with reference to FIGS. 4-7.

Determining a Respective Price to be Charged to the Source of the One or More Electronic Messages Included in the Winning One of the Plurality of Stencils 224

Then, at sub-process 812, the network resource 212 determines a respective price to be charged to a source of each of the targeted electronic message set of targeted electronic messages that forms part of the winning one of the plurality of stencils.

In some non-limiting embodiments of the present technology, the respective price is calculated based on (i) a bid value and (ii) a placement in the dedicated placement pattern of each one of the set of targeted electronic messages that forms part of the winning one of the plurality of stencils. In some non-limiting embodiments of the present technology, the respective price is calculated further based on the reserve price established for the given bid auction.

In some non-limiting embodiments of the present technology, the respective price for a given one of the set of targeted electronic messages is calculated as a function of a displacement value of the given one of the set of targeted electronic messages relative to a remainder of the set of targeted electronic messages.

In some non-limiting embodiments of the present technology, the determining the respective price (P) for a given one of the set of candidates having been assigned to the given one of the plurality of stencils comprises applying a formula:

P=V₁−(TV−V₁) Equation 2

where
P is the respective price;
V₁ is the total value of the set of candidates having been assigned to the given one of the plurality of stencils;
TV−V₁ is a hypothetical total the set of candidates having been assigned to the given one of the plurality of stencils if the given one of the set of candidates was not included.

In some embodiments of the present technology, the process can be repeated (starting with the sub-process 802) for another instance of the bid auction to provide another targeted electronic message to another user.

Truthfull-Ness Based Auctions

As has been briefly alluded to above, at least some embodiments of the present technology are based on the truthfull-ness principle of electronic bid auctions. In accordance to the various non-limiting embodiments of the present technology execution of the sub-process 806 (the selecting the respective set of targeted electronic messages out of possible combinations of the plurality of candidates for the targeted electronic message) and sub-process 808 (the selecting the given one of the plurality of stencils having been assigned the plurality of candidates for the targeted electronic message) contribute, at least partially, to adherence to the truthfull-ness principle of electronic bid auctions.

In at least some other non-limiting embodiments of the present technology, the fact that the weight parameters for each one of the plurality of stencils 225 are selected independent of the bid price also contribute, at least partially, to the adherence to the truthfull-ness principle of electronic bid auctions.

Given the architecture described above, it is possible to execute a method for transmitting a targeted electronic message for the user 204 of the electronic device 202. The methods can be executed by the network resource server 210.

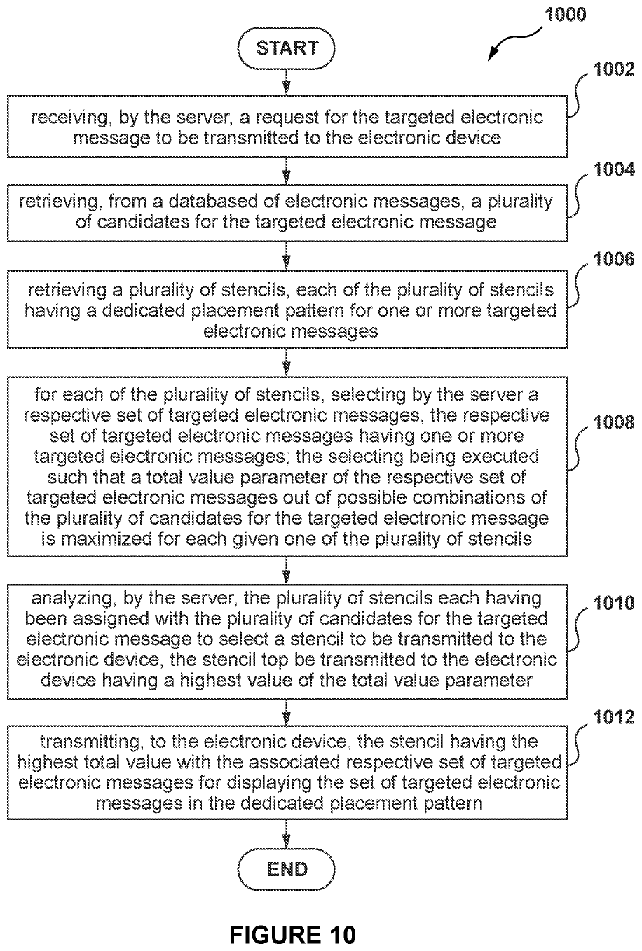

With reference to FIG. 10, there is depicted a block diagram of a method 1000, the method 1000 being implemented in accordance with non-limiting embodiments of the present technology.

Step 1002—Receiving, by the Server, a Request for the Targeted Electronic Message to be Transmitted to the Electronic Device

The method 1000 begins at step 1002 with receiving, by the network resource 212, a request for the targeted electronic message to be transmitted to the electronic device 202.

Step 1004—Retrieving, from a Databased of Electronic Messages, a Plurality of Candidates for the Targeted Electronic Message

At step 1004, the network resource 212 retrieves, from a databased of electronic messages, a plurality of candidates for the targeted electronic message.

Step 1006—Retrieving a Plurality of Stencils, Each of the Plurality of Stencils Having a Dedicated Placement Pattern for One or More Targeted Electronic Messages

At step 1006, the network resource 212 retrieves a plurality of stencils 224, each of the plurality of stencils 224 having a dedicated placement pattern for one or more targeted electronic messages.

Step 1008—For Each of the Plurality of Stencils, Selecting by the Server a Respective Set of Targeted Electronic Messages, the Respective Set of Targeted Electronic Messages Having One or More Targeted Electronic Messages, the Selecting being Executed Such that a Total Value Parameter of the Respective Set of Targeted Electronic Messages Out of Possible Combinations of the Plurality of Candidates for the Targeted Electronic Message is Maximized for Each Given One of the Plurality of Stencils

At step 1008, for each of the plurality of stencils, the network resource 212 selects a respective set of targeted electronic messages, the respective set of targeted electronic messages having one or more targeted electronic messages, the selecting being executed such that a total value parameter of the respective set of targeted electronic messages out of possible combinations of the plurality of candidates for the targeted electronic message is maximized for each given one of the plurality of stencils 224.

Step 1010—Analyzing, by the Server, the Plurality of Stencils Each Having been Assigned with the Respective Set of Targeted Electronic Messages to Select a Winning One of the Plurality of Stencils, the Winning One of the Plurality of Stencils Having a Highest Value of the Total Value Parameter

At step 1010, the network resource 212 analyzes the plurality of stencils 224 each having been assigned with the respective set of targeted electronic messages to select a winning one of the plurality of stencils 224, the winning one of the plurality of stencils 224 having a highest value of the total value parameter.

Step 1012—Transmitting, to the Electronic Device, the Winning One of the Plurality of Stencils Having the Highest Total Value with the Associated Respective Set of Targeted Electronic Messages for Displaying the Set of Targeted Electronic Messages in the Dedicated Placement Pattern

At step 1012, the network resource 212 transmits, to the electronic device 202, the winning one of the plurality of stencils 224 having the highest total value with the associated respective set of targeted electronic messages for displaying the set of targeted electronic messages in the dedicated placement pattern.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for transmitting a targeted electronic message for a user of an electronic device, the method executable by a server coupled to the electronic device via a communication network, the method comprising:
receiving, by the server, a request for the targeted electronic message to be transmitted to the electronic device;
retrieving, from a database of electronic messages, a plurality of candidates for the targeted electronic message;
retrieving a plurality of stencils, each of the plurality of stencils having a dedicated placement pattern for one or more targeted electronic messages;
for each of the plurality of stencils, selecting by the server a respective set of targeted electronic messages, the respective set of targeted electronic messages having one or more targeted electronic messages,
the selecting being executed such that a total value parameter of the respective set of targeted electronic messages out of possible combinations of the plurality of candidates for the targeted electronic message is maximized for each given one of the plurality of stencils;
analyzing, by the server, the plurality of stencils each having been assigned with the respective set of targeted electronic messages to select a stencil to be transmitted to the electronic device, the stencil to be transmitted to the electronic device having a highest value of the total value parameter;
transmitting, to the electronic device, the stencil to be transmitted with the associated respective set of targeted electronic messages for displaying the set of targeted electronic messages in the dedicated placement pattern.

2. The method of claim 1, wherein the selecting by the server the respective set of targeted electronic messages comprises executing a max matching optimization algorithm.

3. The method of claim 1, wherein the selecting by the server the respective set of targeted electronic messages comprises, for the each given one of the plurality of stencils:
iteratively placing a given one of the plurality of candidates for the targeted electronic message for each of a placement slots of the each given one of the plurality of stencils, and
selecting a given combination of the candidates for the targeted electronic message that maximizes the total value parameter, the given combination of the candidates for the targeted electronic message defining the respective set of targeted electronic messages.

4. The method of claim 1, wherein an individual value parameter for a given one of the plurality of candidates for the targeted electronic message placed on a given placement position of a given one of the plurality of stencils is determined based on at least one of:
a bid value associated with a given one of the candidates for the targeted electronic message;
a predicted click probability parameter;
a predicted relevancy parameter;
a predicted target action probability parameter;
a pre-determined reserve price.

5. The method of claim 4, wherein the total value parameter is based on an amalgamation of all individual target value parameters of the set of targeted electronic messages assigned to the given one of the plurality of stencils.

6. The method of claim 4, wherein at least some of the predicted click probability parameter, the predicted relevancy parameter, the predicted target action probability parameter are determined by a Machine Learning Algorithm (MLA).

7. The method of claim 6, wherein each of the predicted click probability parameter, the predicted relevancy parameter, the predicted target action probability parameter are determined by the Machine Learning Algorithm (MLA).

8. The method of claim 6, wherein each of the predicted click probability parameter, the predicted relevancy parameter, the predicted target action probability parameter are determined by a respective Machine Learning Algorithm (MLA).

9. The method of claim 4, wherein the pre-determined reserve price is pre-determined by an operator of the server.

10. The method of claim 4, wherein the bid value associated with the given one of the candidates for the targeted electronic message is pre-determined by a source of the given one of the candidates for the targeted electronic message.

11. The method of claim 10, wherein the bid value associated with the given one of the candidates for the targeted electronic message is pre-determined by the source of the given one of the candidates for the targeted electronic message independently from other bid values pre-determines by other sources of other ones of the plurality of candidates for the targeted electronic message.

12. The method of claim 1, wherein each of the plurality of stencils is associated with a weight parameter.

13. The method of claim 12, wherein the weight parameter is representative of a displacement factor of at least some slots of the dedicated placement pattern.

14. The method of claim 13, wherein the weight parameter is further representative of a relative traffic exposure of the at least some slots of the dedicated placement pattern compared to at least some other slots of the dedicated placement pattern.

15. The method of claim 13, wherein the weight parameter is determined independently from a respective bid value associated with a given one of the plurality of candidates for the targeted electronic message.

16. The method of claim 15, wherein the weight parameter is determined prior to the receiving the request for the targeted electronic message to be transmitted to the electronic device.

17. The method of claim 12, wherein the highest value of the total value parameter is selected based on respective total value parameter of each of the plurality of stencils modified by the weight parameter.

18. The method of claim 17, wherein the respective total value parameter is determined by summing up individual values of targeted electronic messages that form the respective set of targeted electronic messages.

19. The method of claim 18, wherein the respective total value parameter is further determined by one of (i) adding the weight parameter to a sum of the individual value parameters of targeted electronic messages that form the respective set of targeted electronic messages and (ii) multiplying the sum by the weight parameter.

20. The method of claim 12, wherein the weight parameter comprises a static component and a dynamic component.

21. The method of claim 20, wherein the static component is pre-determined for each of the plurality of stencils.

22. The method of claim 21, wherein the static component is pre-determined based on one of an experiment and a simulation based on a historical data.

23. The method of claim 21, wherein a respective static component is pre-determined for each of the plurality of stencils using a black box optimization algorithm.

24. The method of claim 23, wherein the respective static component is selected by the black box optimization algorithm such that to optimize a given function with a minimum threshold for an auxiliary function.

25. The method of claim 20, wherein the dynamic component is dynamically calculated for each of the plurality of stencils during the analyzing, by the server, the plurality of stencils.

26. The method of claim 25, wherein the dynamic component for a given one of the plurality of stencils is calculated as a function of at least: (i) features of the respective set of targeted electronic messages assigned to the given one of the plurality of stencils; (ii) features of the request for the targeted electronic message to be transmitted to the electronic device.

27. The method of claim 20, wherein the dynamic component is used for filtering out at least some of the plurality of stencils prior to the selecting the stencil to be transmitted.

28. The method of claim 27, wherein the selecting the stencil to be transmitted comprises selecting from a remainder of the plurality of stencils after the filtering; the selecting being done based on the static component and the dynamic component of the remainder of the plurality of stencils after the filtering.

29. The method of claim 1, wherein the method further comprises determining a respective price to be charged to a source of each of targeted electronic messages of the set of targeted electronic messages that forms part of the stencil to be transmitted of the plurality of stencils.

30. The method of claim 29, wherein the respective price is calculated based on (i) a bid value and (ii) a placement in the dedicated placement pattern of each one of the set of targeted electronic messages that forms part of the stencil to be transmitted of the plurality of stencils.

31. The method of claim 29, wherein the respective price for a given one of the set of targeted electronic messages is calculated as a function of a displacement value of the given one of the set of targeted electronic messages relative to a remainder of the set of targeted electronic messages.

32. The method of claim 29, wherein the determining the respective price (P) for a given one of the set of candidates having been assigned to the given one of the plurality of stencils comprises applying a formula:
P=V₁−(TV−V₁),
where
P is the respective price;
V₁ is the total value of the set of candidates having been assigned to the given one of the plurality of stencils;
TV−V₁ is a hypothetical total the set of candidates having been assigned to the given one of the plurality of stencils if the given one of the set of candidates was not included.

33. The method of claim 1, wherein the dedicated placement pattern comprises at least one of:
a number of targeted electronic messages to be included;
a relative placement on a screen of the electronic device of the targeted electronic messages included in the associated one of the plurality of stencils;
a relative size of the targeted electronic messages included in the associated one of the plurality of stencils;
details to be included in each of the targeted electronic messages.

34. The method of claim 33, wherein the relative placement of a given targeted electronic message is one of: above an organic search result, below the organic search result, at one side of an organic search result, as part of a search query suggest, and as part of a search result snippet.

35. The method of claim 33, wherein details include at least one of a textual description, an image, a map, a link, and a user interaction element.

36. The method of claim 1, wherein the dedicated placement pattern comprises an indication of a dynamic placement pattern for at least some of the targeted electronic messages to be included in the associated one of the plurality of stencils.

37. The method of claim 36, wherein the dynamic placement pattern comprises at least one:
a sticking pattern of display of a top message of the targeted electronic messages;
a repeating pattern of display of the top message of the targeted electronic messages.

38. The method of claim 1, wherein the plurality of candidates for the targeted electronic message comprises a first plurality of candidates for the targeted electronic message, and wherein the retrieving, from the databased of electronic messages, the plurality of candidates for the targeted electronic message comprises:
retrieving, from the databased of electronic messages, a second plurality of candidates for the targeted electronic message;
selecting the first plurality of candidates for the targeted electronic message from the second plurality of candidates for the targeted electronic message, the first plurality of candidates for the targeted electronic message being a subset of the second plurality of candidates for the targeted electronic message;
the selecting being executed based on at least a relevance parameter of each of the second plurality of candidates for the targeted electronic message to the user.

39. The method of claim 38, wherein the receiving the request for the targeted electronic message to be transmitted to the electronic device is executed as part of receiving a search request, and wherein the relevance parameter is based on relevancy of each of the second plurality of candidates for the targeted electronic message to a search query submitted as part of the search request.

40. The method of claim 1, wherein the receiving the request for the targeted electronic message to be transmitted to the electronic device comprises receiving the request from the electronic device.

41. The method of claim 1, wherein the receiving the request for the targeted electronic message to be transmitted to the electronic device comprises receiving the request from an auxiliary server.

42. The method of claim 1, wherein the receiving the request for the targeted electronic message to be transmitted to the electronic device comprises generating the request by the server in response to the user requesting an access to a network resource hosted by the server.

43. The method of claim 1, wherein the targeted electronic message is an electronic ad banner.

44. The method of claim 1, wherein the targeted electronic message is a non-organic search results to be included into a Search Engine Result Page (SERP).

45. The method of claim 1, wherein the steps of:
the selecting the respective set of targeted electronic messages out of possible combinations of the plurality of candidates for the targeted electronic message; and
the selecting the given one of the plurality of stencils having been assigned the respective set of targeted electronic messages;
are both executed based on a truthfull-ness principle of electronic bid auctions.

46. A server for transmitting a targeted electronic message for a user of an electronic device, the server comprising:
a communication interface for communicating with the electronic device via a communication network,
a processor storing computer executable instructions, which instructions when executed cause the server to:
receive a request for the targeted electronic message to be transmitted to the electronic device;
retrieve, from a database of electronic messages, a plurality of candidates for the targeted electronic message;
retrieve a plurality of stencils, each of the plurality of stencils having a dedicated placement pattern for one or more targeted electronic messages;
for each of the plurality of stencils, select a respective set of targeted electronic messages, the respective set of targeted electronic messages having one or more targeted electronic messages,
the selecting being executed such that a total value parameter of the respective set of targeted electronic messages out of possible combinations of the plurality of candidates for the targeted electronic message is maximized for each given one of the plurality of stencils;
analyze the plurality of stencils each having been assigned with the respective set of targeted electronic messages to select a stencil to be transmitted to the electronic device out of the plurality of stencils, the stencil to be transmitted having a highest value of the total value parameter;
transmit, to the electronic device, the stencil to be transmitted with the associated respective set of targeted electronic messages for displaying the set of targeted electronic messages in the dedicated placement pattern.
